(19) United States
(12) Patent Application Publication
(10) Pub. No.: US 2021/0325570 A1
(43) Pub. Date: Oct. 21, 2021

(54) Easy To Clean And Anti-Fog Coating With Anti-Reflective Properties

(71) Applicant: Vision Ease, LP, Ramsey, MN (US)

(72) Inventors: Tim Reynolds, Ramsey, MN (US); Sandy Goebel, Ramsey, MN (US); Robin Kezar, Ramsey, MN (US); Jeffrey Brown, Ramsey, MN (US)

(73) Assignee: Vision Ease, LP, Ramsey, MN (US)

(21) Appl. No.: 17/233,325

(22) Filed: Apr. 16, 2021

Related U.S. Application Data
(60) Provisional application No. 63/011,884, filed on Apr. 17, 2020.

(51) Int. Cl. G02B 1/111; C09D 5/00; C09D 7/42; C09D 7/65; C09D 7/63; C09D 7/48; C09D 183/06

(52) U.S. Cl. CPC G02B 1/111; C09D 5/006; C09D 7/42; C08K 5/3432; C09D 7/63; C09D 7/48; C09D 183/06; C09D 7/65

(57) ABSTRACT

An ophthalmic article having a coating system which provides antireflective, easy clean and anti-fogging properties to the ophthalmic article. The coating system includes alternating layers of low refractive index and high refractive index metal oxides and a sol-gel based hydrophilic top layer formed of one or more silanes, one or more alcohols, DI water and itaconic acid. The coating system provides favorable surface energy and particle size distribution to the ophthalmic article when the sol-gel based top layer is deposited on top surface of the alternating layers of low refractive index and high refractive index metal oxides.

### RELATED APPLICATIONS

This application claims priority to U.S. Provisional Application Ser. No. 63/011,884 filed Apr. 17, 2020 entitled Easy To Clean Coating With Anti-Reflective Properties And Improved Performance, which is hereby incorporated herein by reference in its entirety.

### FIELD OF THE INVENTION

The present invention is directed to optical coatings and, more particularly, to hydrophilic coatings that are easy to clean, anti-reflective, anti-fogging and have improved stability against mechanical actions, such as rubbing and abrasion.

### BACKGROUND OF THE INVENTION

One or more functional coatings can be applied to a surface of an ophthalmic article in order to impart different properties or characteristics to its surface. Such properties or characteristics imparted by the coatings may include color, gloss, reflectivity, abrasion resistance, optical clarity, water repellency, resistance to fogging, anti-reflectivity, resistance to soiling, and ease of cleaning. Of these various properties, the surface properties or characteristics of ease of cleaning, antifogging and anti-reflectivity have potentially broad applications in ophthalmic industries.

Dirt, oil, and dust are the major contaminants that build up on an ophthalmic lens. Depending on the wearer's environment, the type of ophthalmic lens coatings, and materials needed to clean them, the removal of these contaminants is ongoing and often challenging.

In order to keep the surfaces of the ophthalmic lenses clean, most of the currently available products use hydrophobic coatings on these lenses. However, these easy-cleaning coating technologies using hydrophobic lens surfaces do not always perform at levels desired by the user. This can be due to the fact that the hydrophobic surfaces are mostly directed towards achieving the highest possible contact angles for both water and oils. Generally, a contact angle of the water of >110° pre rub and >105° post rub is normally used. Such high contact angles of water and oils, however, do not always indicate an easy to clean surface since, in absence of friction from the surface, the water/oils mixed with dirt tend to move or smear across the slippery lens surface. Also, the performance of the hydrophobic surface may not be sufficiently long. For example, the hydrophobic coating deteriorates or abrades off overtime during the lens cleaning. When this occurs, oils and dirt build up on the lens and can be difficult to remove without the use of soap or similar cleaning solutions.

Other technologies employ the use of a hydrophilic coating layer, usually composed of a material that has a permanent hydrophilicity. However, these types of coatings are typically not durable and cannot be used in applications where abrasion is present.

In optical industries, it is often desirable to combine the properties or characteristics of ease of cleaning with other functional properties or characteristics, for example, anti-fogging. However, the inherent hydrophobicity of current easy-cleaning coatings renders them undesirable for fogging resistance since water droplets are capable of adhering to such coatings in a partially non-wetted state, creating the appearance of fogging by way of light scattering.

In addition, commercially available hydrophilic anti-fogging coatings do not necessarily lend themselves to being cleanable based on their inherent surface energetic properties. Accordingly, current coatings are marketed as either easy to clean or having anti-fogging properties but not both. As a result, there is lack of a coating system that combines both properties in a durable and manufacturable way.

U.S. Pat. No. 10,613,255 B2, the contents of which is hereby incorporated by reference, discloses a hydrophilic coating for ophthalmic lenses that has anti-reflecting (AR) properties and imparts improved cleanability. The hydrophilic coating is a sol-gel layer formed by one or more silanes, alcohols and water and deposited as a top layer on an AR stack and completes the AR stack.

This sol-gel based hydrophilic coating imparts a unique surface energy in the range of 30-90 millijoules which is essentially permanent. This range of surface energy imparts an increased hydrophilic nature relative to the hydrophobic layer used in conventional AR coatings. This energy range is found to provide improved anti-fouling and cleanability, as disclosed in the ease of removal of sebum from the coating surface.

Although the hydrophilic coating disclosed in U.S. Pat. No. 10,613,255 B2 shows essentially permanent surface energy which is not degraded by weathering (as simulated in industry standard Quv testing), it may, however, be possible that this hydrophilic coating may degrade by mechanical actions, for example, rubbing or abrasion, which may reduce or remove the sol-gel layer performance over time.

Hence, there exists a need to develop a sol-gel based top hydrophilic coating on an AR stack that has superior characteristics by providing surface robustness against rubbing and abrasion and provides easy cleaning, anti-reflective and anti-fogging properties over longer periods of time.

### OBJECTS AND SUMMARY OF THE INVENTION

The present invention provides coatings and coating systems that impart effective easy-cleaning, anti-reflective and anti-fogging properties to a surface of an article. The coating system is obtained, in part, through providing an ophthalmic article comprising: a substrate having a first surface; a plurality of refractive layers of alternating low refractive index and high refractive index metal oxides, a first of the plurality of refractive layers deposited directly on the first surface and a last of the plurality of refractive layers forming a second surface; and a top layer, formed of one or more silanes, one or more alcohol, DI water and an acid comprising trifunctional groups of two carboxylic acids and an α,β-unsaturated double bond, is deposited on the second surface. The coating system comprises a surface energy in a range of approximately 30 to 90 millijoules per square meter and particle sizes having dimensions in a range of approximately 20 to 30 nanometers.

In a preferred embodiment, a method of forming an optical coating composition that imparts an easy-cleaning, an anti-fogging and an anti-reflecting properties on a surface of an article comprises: forming a first mixture in a first step by combining: i) at least one silane of R₁Si(OR₂)₃, wherein R₁ comprises a reactive organic epoxide group and R₂ is a methyl group, an ethyl group, a propyl group or an isopropyl group; ii) an alcohol component, iii) DI water, and iv) an acid having trifunctional groups comprising two carboxylic acid groups and an α,β-unsaturated double bond. The first mixture is stirred to allow the mixture to cool down to room temperature and v) a silane compound having a formula Si(OR₂)₄, wherein R₂ is a methyl group, an ethyl group, a propyl group or an isopropyl group, is added to the reaction mixture in the first step. In the second step of the synthesis, the first mixture is diluted by adding at least one additional alcohol component from the first step of the synthesis. The second mixture is cured at 50° C. for 72 hours to obtain an optical coating composition that imparts an easy-cleaning, an anti-fogging and an anti-reflecting properties on a surface of an ophthalmic article.

In some embodiments, the acid used in the first step of the synthesis maintains a pH of the final reaction mixture at 3.2, crosslinks with the available reactants and improves the mechanical robustness of the optical coating.

The optical coating disclosed in the present application imparts an easy-cleaning, anti-reflective and anti-fogging properties on a cured surface comprising pores having diameters in a range of approximately 20 to 30 nanometers and a surface energy in a range of approximately 30 to 90 millijoules per square meter.

### BRIEF DESCRIPTION OF THE DRAWINGS

These and other aspects, features and advantages of which embodiments of the invention are capable will be apparent and elucidated from the following description of embodiments of the present invention, reference being made to the accompanying drawings, in which:

FIG. 1 is a perspective view of a coated substrate according to one embodiment of the present invention.

FIG. 2 is a graph showing changes of surface energy of an optical coating composition stabilized with a mixture of sulfuric acid and itaconic acid over 25 days according to one embodiment of the present invention.

FIG. 3 is a graph showing particle size distribution of an optical coating composition stabilized with a mixture of sulfuric acid and itaconic acid over 25 days according to one embodiment of the present invention.

FIG. 4 is a table showing Colts Rub test results of an optical coating composition stabilized with a mixture of sulfuric acid and itaconic acid over 21 days according to one embodiment of the present invention.

FIG. 5 is a table showing dilution of the optical coating solution a according to one embodiment of the present invention.

FIG. 6 is a graph showing a comparative study of the changes of surface energy of an optical coating composition stabilized with a mixture of sulfuric acid and itaconic acid versus changes of surface energy of an optical coating composition stabilized with only itaconic acid.

FIG. 7 is a graph showing a comparative study of particle size distribution of an optical coating composition stabilized with a mixture of sulfuric acid and itaconic acid versus particle size distribution of an optical coating composition stabilized with only itaconic acid.

FIG. 8 is a table showing Colts Rub test results of an optical coating composition stabilized with only itaconic acid over 12 days according to one embodiment of the present invention.

FIG. 9 is a graph showing FTIR studies of diminishing absorbance of C═O peaks of unbound itaconic acid at different temperatures.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements. While different embodiments are described, features of each embodiment can be used interchangeably with other described embodiments. In other words, any of the features of each of the embodiments can be mixed and matched with each other, and embodiments should not necessarily be rigidly interpreted to only include the features shown or described.

In a preferred embodiment, the present invention provides a hydrophilic coating system of an ophthalmic article which uses an organic acid, for example, itaconic acid, as a stabilizer to improve the shelf-life or the stability of the resulting easy-cleaning coating solution. In some embodiments, the coating solution comprises a sol-gel layer formed by one or more silanes, alcohols, water and itaconic acid. Itaconic acid comprises two carboxylic acid functionalities and an α,β-unsaturated double bond. The trifunctional structure of the Itaconic acid allows cross-linking with the available reactants in the reaction medium, and, therefore, makes it a desirable precursor into coating formulations to improve coating hardness. The use of itaconic acid as a stabilizer reduces the surface tension of the easy clean coating and controls the particle size distribution towards relatively smaller particles, which are important aspects of the mechanical integrity of the coating.

In some embodiments of the present invention, an ophthalmic article comprises a substrate having a first surface; a first of a plurality of refractive layers deposited directly on said first surface and a last of the plurality of refractive layers forming a second surface. A top layer of hydrophilic easy clean coating is deposited on the second surface. The hydrophilic easy clean coating comprises a surface energy in a range of approximately 30 to 90 millijoules per square meter. The ophthalmic article comprises refractive index in a range of approximately 1.40 to 1.49 at a wavelength of 589 nanometers. The ophthalmic article shows improved easy clean and antireflective properties after the top hydrophilic coating is deposited on the second surface. In some embodiments, the surfaces of ophthalmic articles which the coating of the present invention can be applied includes, but is not limited to, glass, plastics, metals, painted or colored surfaces, and other materials where cleanability is desirable.

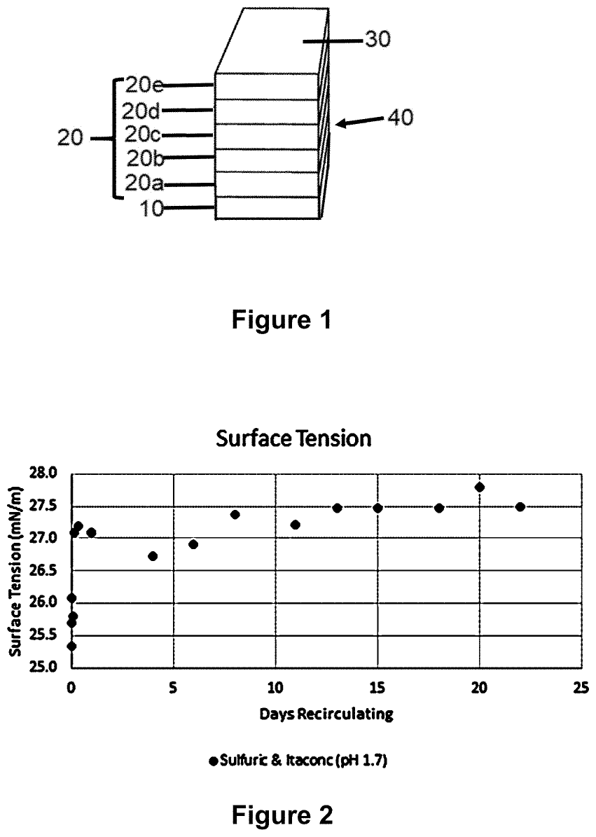

In certain embodiments of the present invention, a surface of an article with a durable anti-reflective and easy-cleaning properties are obtained. With reference to FIG. 1, a pre-tuned anti-reflective stack 20 is applied to a surface of a substrate 10. The pre-tuned anti-reflective stack 20 may employ, for example, alternating high and low refractive index layers of 20a through 20n. The refractive layers 20a through 20n may comprise alternating layers of silicon dioxide and either titanium dioxide or tantalum pentoxide; alternating layers of silicon dioxide and zirconium dioxide; or alternating layers of silicon, silicon dioxide, and titanium dioxide. The designators 20a through 20n are intended to mean that the number of refractive layers applied is not limited.

The pre-tuned anti-reflective stack 20 will not have anti-reflective properties until the easy-cleaning layer or coating 30 is applied as a final layer on the top surface (20e in FIG. 1) of the pre-tuned anti-reflective stack 20. Once the easy-cleaning layer or coating 30 is applied to the pre-tuned anti-reflective stack 20, a tuned easy clean and anti-reflective stack 40 is formed.

In one embodiment, a refractive index of the resulting easy-clean layer or coating, i.e. the refractive index of an optical article having a tuned anti-reflective stack as defined above, is in a range of approximately 1.40 to 1.49 measured at 589 nanometers.

An adhesive or adhesives may be employed in, among, on, and/or under any of the other functional coatings or layer present on the substrate.

In one embodiment, the top layer of the easy clean coating is hydrophilic in nature and it is synthesized in a two-step process.

In a first step, an alcohol, a silane and DI water are mixed together until the mixture becomes homogenous and allowed to react for a period, for example, 4 hours. Next, a combination of acids, for example, a mixture of sulfuric acid and itaconic acid, is added to the reaction mixture and the mixture is stirred for extended period until the temperature of the mixture returns to room temperature. In some embodiments, the silane employed is, for example, a glycidoxypropyltrimethoxysilane (GPTMS).

Next, a second silane, for example, a tetramethyl orthosilicate (TMOS) is added to the reaction mixture and the reaction mixture is stirred for a period, for example, 2-4 hours. In one preferred embodiment, these silanes (TMOS:GPTMS) are combined at a molar ratio ranging from approximately 19:1 to 1:1 or from approximately 4:1 to 3:2. In one preferred embodiment, a molar ratio of DI water to the total moles of silanes is in a range 11.13:1. The combination of acids, for example, a mixture of sulfuric acid and itaconic acid are added by saturating the DI water during the hydrolysis and condensation reactions of the GPTMS and TMOS mixture. In one preferred embodiment, a molar ratio of the sulfuric acid to the total moles of silanes are in a range of 1:30.1. One preferred embodiment, a molar ratio of the itaconic acid to the total moles of silanes are in a range of 1:8.13.

In some embodiments, exchanging a strong acid, such as, hydrochloric acid with another strong acid, such as sulfuric acid, does not impact the outcome of the reaction. In some embodiments, the first step of the two-step synthesis may be exothermic in nature. Therefore, it may be desirable to allow the reaction mixture to return to room temperature before proceeding to the second step of the synthesis.

In some embodiments, a molar ratio of sulfuric acid and itaconic acid in the first mixture is in a range of about 1:3.7. In some embodiments, the first mixture after adding the combination of sulfuric acid and itaconic acid may have a pH of 1.7.

Ina second step of the two-step synthesis process, a second mixture is formed by combining a portion of the first mixture with additional alcohol or alcohols. The second step of the reaction aids in regulating evaporation and surface tension gradient behavior during subsequent drying of the coating solution. The alcohol employed in the second mixture is optionally the same as the alcohol employed in the first mixture and is selected from alcohols having the general formula R—OH, where R is a methyl, ethyl, propyl, or isopropyl group, but is preferably a methyl group.

Next, the reaction mixture from the second step is thermally cured to remove any residual solvent that may be present. Curing is achieved in a range of temperatures and for certain time periods, for example, at 125 to 130 degrees Celsius for approximately 3 hours. In a preferred embodiment curing is achieved at 50 degrees Celsius for approximately 3 days.

In some embodiments, a sample of the compound generated from the second step is diluted for use. A control of the coating thickness and uniformity of the resulting easy-cleaning coating solution is achieved by dilution of the second mixture, by the addition of high surface tension reducing agents or surfactants.

In a preferred embodiment, at least one high surface tension reducing surfactant/agent is added for the dilution. A high surface tension reducing surfactant/agent may, for example, be a silicone-containing surface additive, such as, a polyether modified polydimethylsiloxane, for example, BYK333 or other silicone-containing surface additives appropriate for solvent-borne coating systems. In addition to BYK333, some alcohols, for example but not limited to methanol, ethanol and 1-methoxy-2-propanol, and DI water may be added for the dilution.

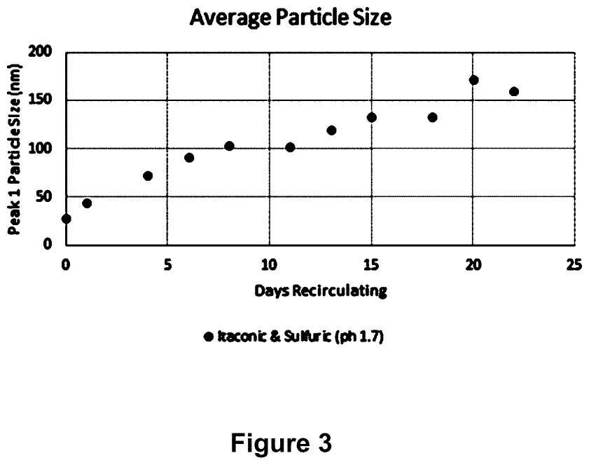

After dilution, a sample of the diluted solution is placed in a coater for number of days with constant recirculation. On each day, the coating solution is measured for particle size distribution and surface tension. The measurements of the surface tension over several days, for example, up to 25 days are shown in FIG. 2. The measurements of the average particle size for the same period are shown in FIG. 3.

As can be seen in FIG. 2, the surface tension of the hydrophilic coating generated from the two-step synthesis described above rises rapidly within the first 24 hours and then slowly increases over next 24 days. This first rapid and subsequent slow increase of the surface tension indicates a change in properties of the hydrophilic coating. The application tests after the first 24 hours demonstrate that the hydrophilic coating undergoes degraded uniformity and reduced performance in terms of cleanability and mechanical robustness.

FIG. 3 shows a plot of monitoring the particle size over the same period of 25 days. It can be seen from FIG. 3 that the average particle size of the hydrophilic coating increases continuously indicating particle instability. The particle size increase of the hydrophilic coating continued throughout the experiment period and the particle size increased beyond the desired range of particles having dimensions in a range of approximately 20 to 30 nanometers. The desired range of particle size distribution is directly related to the mechanical integrity of the hydrophilic coating. Larger particle sizes effectively reduce the load-bearing portions of the particles and thereby reduce the mechanical integrity of the final coating. Controlling smaller particle sizes is an important aspect of the present invention. Smaller particles result in smaller effective pore sizes and improve the load-bearing capacity of the particles and thereby, improve the mechanical integrity of the final hydrophilic easy clean coating.

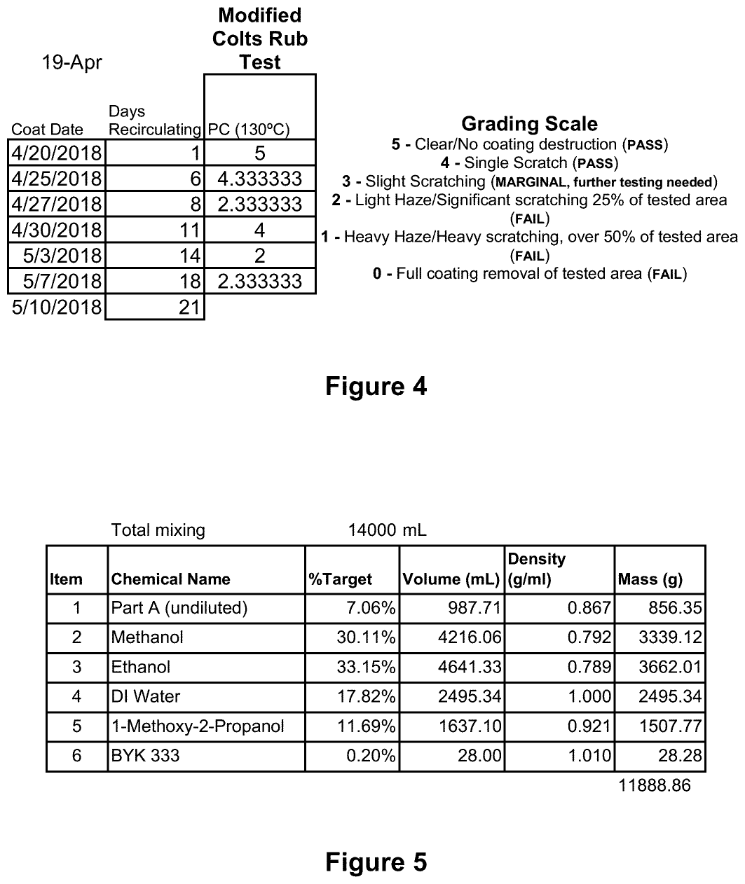

FIG. 4 shows a table which demonstrates that the changes in material properties of the hydrophilic easy clean coating, as shown in surface tension and particle size distribution experiments in FIGS. 2 and 3, are related to the changes in the mechanical robustness of the hydrophilic coating. The mechanical robustness of the hydrophilic coating is determined by the modified Colt Rub test. The rub test result from FIG. 4 demonstrates that the hydrophilic easy clean coating does not degrade when the rub test is performed after 1 day of placing the diluted coating solution in a coater with constant recirculation. This is shown in FIG. 4 with a value 5 of the test result which indicates a clear coating or no coating destruction. However, other values of the Colt Rub test result from FIG. 4 show that the stability of the hydrophilic easy clean coating decreases and degrades after day number 6 with a value of the Rub test lower than 3. FIG. 4 shows that a value of the Rub test result lower than 3 indicates light haze and significant scratches on the surface of the hydrophilic easy clean coating. In some embodiments, the haze and scratches cover about 25% of the surface of the tested area. Although this demonstrates the efficacy of the present invention, it is desirable to increase the coating stability.

It has been concluded that the presence of the strong acid, such as, sulfuric acid in combination with itaconic acid in the first step of the two-step synthesis renders the final hydrophilic easy clean coating solution highly acidic with a low pH of 1.7. This low pH is likely detrimental to the stability of the surfactant of a polyether modified polydimethylsiloxane, for example, BYK333 used to reduce the high surface tension of the hydrophilic easy clean coating during dilution. At pH 1.7, the BYK333 may get decomposed, and the resulting fragments then become integrated into the coating resulting in degraded performance. The removal of the surfactant reduces the coating uniformity and further degrades the coating.

To overcome the problem of degradation of the high surface tension reducing surfactant under highly acidic reaction condition, the two-step synthesis of the hydrophilic easy clean coating is performed with only one acid, namely, the itaconic acid and without the addition of the sulfuric acid. Performing the two-step synthesis with the addition of itaconic acid only in the first step renders the final hydrophilic easy clean coating solution less acidic with a higher pH of 3.2 compared to the lower pH of 1.7 when sulfuric acid and itaconic acids are combined in the first step of the synthesis. In some embodiments, the stability of the high surface tension reducing surfactant, for example, BYK333, remained intact at pH 3.2.

### Synthesis of Easy Clean Coating Using Itaconic Acid:

One embodiment of the synthesis of the easy clean coating by using one acid, namely itaconic acid, in the first step is described herein.

In the first step of the synthesis, 465 mL of methanol, 205 mL of 3-glycidoxypropyltrimethoxysilane and 622 mL of DI water were mixed together in a container until homogeneity was achieved and the mixture was allowed to react for 4 hours. Then 49.4 gm of itaconic acid was added to the mixture and the mixture was stirred. This step was exothermic and the reaction mixture was allowed to return to room temperature before adding 322.8 mL of TMOS. The container was sealed and shook to ensure homogeneity of the mixture. The reaction mixture was cooled down to room temperature typically within 2-4 hours.

In the second step of the synthesis, 6.4 L of methanol was added to the reaction mixture. The container was sealed again and placed in an oven at 50 degrees Celsius for 72 hours to complete the reaction.

After 72 hours of curing at 50 degrees Celsius, the coating solution obtained after the second step of the synthesis was diluted with one or more alcohols, for example but not limited to methanol, ethanol, 1-methoxy-2 propanol, DI water and a surfactant, for example, BYK333. A 7.06% by volume of undiluted reaction mixture was diluted with 30.11% by volume of methanol and 33.15% by volume of ethanol, 17.82% by volume of DI water, 11.69% by volume of 1-methoxy-2 propanol and 0.2% by volume of BYK333, as can be seen in FIG. 5.

After dilution, a sample of the diluted solution is placed in a coater for number of days with constant recirculation. On each day, the coating solution was measured for surface tension and particle size distribution.

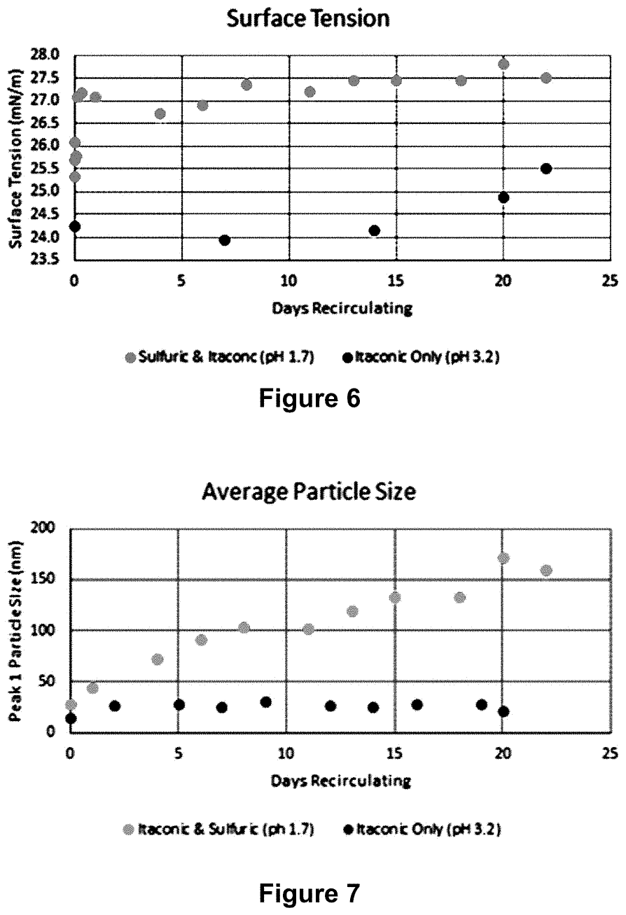

FIG. 6 shows a comparative study of the measurements of the surface tension over 25 days when the first step of the synthesis of the easy clean coating includes a combination of sulfuric acid and itaconic acid (pH of the reaction mixture is 1.7) versus when the first step of the synthesis of the easy clean coating includes only itaconic acid (pH of the reaction mixture is 3.2). The removal of combination of sulfuric acid and itaconic acid (pH 1.7) and replacing with only itaconic acid as a stabilizer of the easy clean coating increases the pH of the reaction mixture around 3.2.

FIG. 6 shows that at pH 3.2, the surface tension of the easy clean coating reduces to and maintains a preferred range of 24-25.5 mN/m without degrading the performance of the coating.

The reason for obtaining the desired range of surface tension may be attributed to the fact that the stability of the high surface tension reducing surfactant, BYK333, remains intact at pH 3.2 and efficiently reduces the surface tension of the easy clean coating to a favorable range. The same solution stability test was repeated and each time the test results showed the clear benefits of the process with regards to the solution stability.

Next, FIG. 7 shows a comparative study of the measurements of the particle size distribution over 25 days when the first step of the synthesis of the easy clean coating includes a combination of sulfuric acid and itaconic acid (pH of the reaction mixture is 1.7) versus when the first step of the synthesis of the easy clean coating includes only itaconic acid (pH of the reaction mixture is 3.2). The removal of combination of sulfuric acid and itaconic acid (pH 1.7) and replacing with only itaconic acid as a stabilizer of the easy clean coating increases the pH of the reaction mixture around 3.2.

FIG. 7 shows that at pH 3.2, the desired range of particle sizes having dimensions in a range of approximately 20 to 30 nanometers were achieved. The desired range of particle size is related directly to the mechanical integrity of the hydrophilic coating. At pH 1.7, the surfactant, for example, BYK333, gets decomposed. The surfactant appears to aid in maintaining separate particles and preventing agglomeration. Therefore, in a mixture of sulfuric acid and itaconic acid, which comprises pH 1.7, the desired range of particle size distribution were not achieved because of the decomposition of the surfactant and the agglomerations of the coating particles.

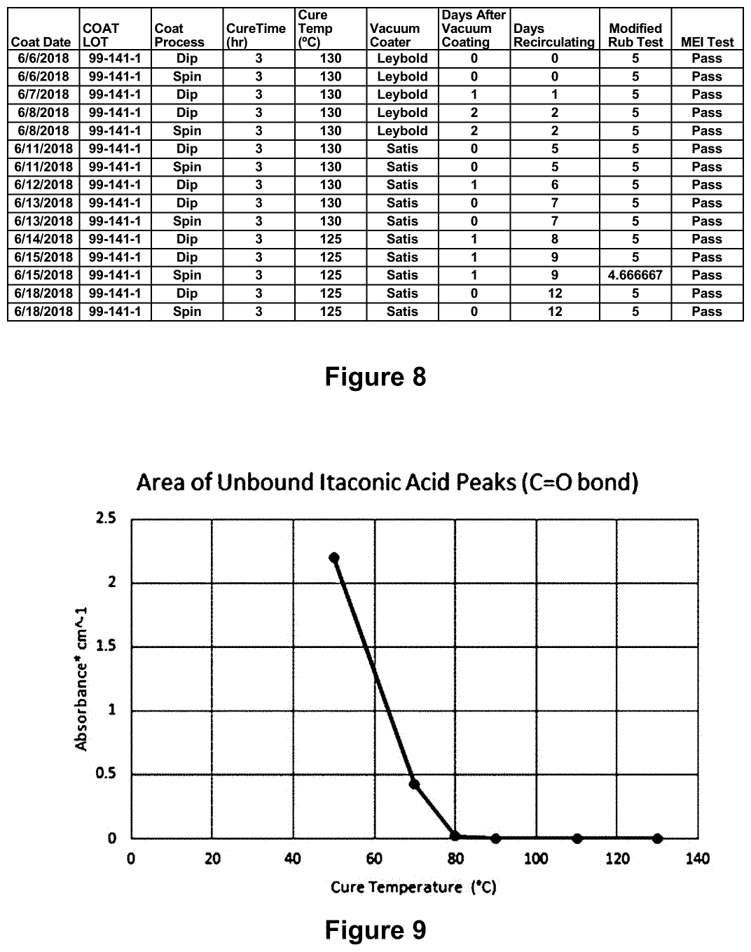

Durability testing of the easy clean coating was performed when the first step of the two-step synthesis of the easy clean coating includes only itaconic acid and maintains the pH of the coating solution at 3.2. FIG. 8 demonstrate the test results. It can be seen from FIG. 8 that even after 12 days with constant recirculation of the coated solution, the value of the Colts rub test remained 5.

These test results indicate that the easy cleaning coating obtains extra mechanical stability when itaconic acid is used as the primary stabilizer. This extra stability of the easy clean coating may be attributed to the trifunctional structure (two carboxylic acid functionalities and an α,β-unsaturated double bond) of the Itaconic acid which provides cross-linking with the available reactants in the reaction medium to generate extra mechanical robustness of the coating which provides favorable surface energy (30-90 milli Joules per square meter) and particle size distribution (20-30 nm).

Based on the foregoing, it is contemplated that any organic acid that has 2 carboxyl groups and one unsaturated C═C bond and has similar properties as itaconic acid is compatible and within the scope of the invention.

FIG. 9 shows FT-IR experiments performed on the coatings at various temperatures to monitor the incorporation of the itaconic acid in the reaction medium. The absorbance of the C═O peak of the itaconic was monitored at different curing temperatures and the reduction of C═O peak intensity is an indication of the incorporation of the itaconic acid into the coating. As shown in FIG. 9, as the curing temperature of the coating was increased, the absorbance of the C═O peak reduced reaching near zero at 80 degrees Celsius indicating near complete consumption of the itaconic acid. This also shows the effective curing to lower temperatures compared to the coating comprising a combination of sulfuric acid and itaconic acid that needed to be cured at higher temperatures (120-130 degrees Celsius).

In optical-based industries, it is often also desirable to combine the properties or characteristics of ease of cleaning and antireflective with functional properties or characteristics such as the property of anti-fogging. However, the inherent hydrophobicity of current easy-cleaning coatings renders them undesirable for fogging resistance since water droplets are capable of adhering to them in a partially non-wetted state, creating the appearance of fogging by way of light scattering.

The present invention demonstrates that by adjusting the ratios of the silanes, for example, tetramethyl orthosilicate (TMOS) and 3-glycidoxypropyltrimethoxysilane (GPTMS), the speed of clearing the condensed moisture, in other words, the anti-fogging advantage, can be achieved in an ophthalmic article in addition to the easy clean and antireflective properties. A volumetric ratio of GPTMS to TMOS may range from 0.2 to 2.0 to impart an anti-fogging property to the ophthalmic article. Such a volumetric ratio between GPTMS and TMOS provides the ophthalmic article characteristics such as ease of cleaning, surface energy, resistance to fogging, and speed of recovery after fogging.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An ophthalmic article having easy-clean and anti-reflective properties comprising:
a substrate having a first surface;
a plurality of layers of alternating high refractive index and low refractive index materials, a first layer of the plurality of layers deposited directly on said first surface of the substrate and a last layer of the plurality of layers forming a second surface; and
a hydrophilic layer distinct from the plurality of layers of alternating high refractive index and low refractive index materials deposited on the second surface, wherein said hydrophilic layer is formed of one or more silanes, one or more alcohols, DI water and an acid;
wherein said acid is configured to crosslink with said one or more silanes and said one or more alcohols and control a pH of a solution of said hydrophilic layer.

2. The ophthalmic article of claim 1, wherein said acid comprises trifunctional groups comprising two carboxylic acids and an α,β-unsaturated double bond.

3. The ophthalmic article of claim 2, wherein said acid is itaconic acid.

4. The ophthalmic article of claim 1, wherein said acid maintains said pH of said solution of said hydrophilic layer at 3.2.

5. The ophthalmic article of claim 2, wherein said trifunctional groups comprising said two carboxylic acids and said α,β-unsaturated double bond of said acid are configured to crosslink with said one or more silanes and said one or more alcohols.

6. The ophthalmic article of claim 5, wherein said cross linking among said two carboxylic acids and said α,β-unsaturated double bond of said acid with said one or more silanes and said one or more alcohols provides mechanical robustness to said hydrophilic layer.

7. The ophthalmic article of claim 6, wherein said mechanical robustness of said hydrophilic layer remains unchanged after 12 days of coating pot-life.

8. The ophthalmic article of claim 1, wherein said hydrophilic layer comprises a surface energy in a range of approximately 30 to 90 millijoules per square meter when said acid is configured to control said pH of said solution of said hydrophilic layer at 3.2.

9. The ophthalmic article of claim 1, wherein said hydrophilic layer comprises pores having diameters in a range of approximately 20 to 30 nanometers when said acid is configured to control said pH of said solution of said hydrophilic layer at 3.2.

10. The ophthalmic article of claim 3, wherein curing of said solution of said hydrophilic layer formed of said one or more silanes, said one or more alcohols, DI water and said itaconic acid occurs at a lower temperature than curing of said solution of said hydrophilic layer formed of said one or more silanes, said one or more alcohols, DI water and a combination of acids comprising sulfuric acid and itaconic acid.

11. The ophthalmic article of claim 10, wherein said curing of said solution of said hydrophilic layer formed of said one or more silanes, said one or more alcohols, DI water and said itaconic acid occurs at 50° C.

12. An optical coating composition that imparts an easy-cleaning, an anti-reflecting and an anti-fogging properties on a surface of an article comprising:
at least one silane of a formula (1);
R₁Si(OR₂)₃(Original)(Original)(Original) (1)
wherein R₁ comprises a reactive organic epoxide group and R₂ is a methyl group, an ethyl group, a propyl group or an isopropyl group;
an alcohol component, DI water, and
a second silane compound having a formula (2),
Si(OR₂)₄(Original)(Original)(Original) (2)
wherein R₂ is a methyl group, an ethyl group, a propyl group or an isopropyl group; and
wherein said optical coating composition further comprising an acid having trifunctional groups comprising two carboxylic acids and an α,β-unsaturated double bond.

13. The optical coating composition of claim 12, wherein a volumetric ratio of said silane of formula (1) and said silane of formula (2) ranges approximately 0.2 to 2.0.

14. The optical coating composition of claim 12, wherein said silane of formula (1) comprises a 3-glycidoxylpropyl group.

15. The optical coating composition of claim 12, wherein said composition further comprises at least one high surface tension reducing surfactant.

16. The optical coating composition of claim 15, wherein said high surface tension reducing surfactant is a silicone-containing surface additive.

17. The optical coating composition of claim 16, wherein said silicone-containing surface additive comprises a polyether modified polydimethylsiloxane.

18. The optical coating composition of claim 12, wherein a pH of said optical coating composition is 3.2.

19. The optical coating composition of claim 18, wherein a hydrophilic layer formed by said composition comprises a surface energy in a range of approximately 30 to 90 millijoules per square meter when said pH of said composition is 3.2.

20. The optical coating composition of claim 18, wherein a hydrophilic layer formed by said composition comprises pores having diameters in a range of approximately 20 to 30 nanometers when said pH of said composition is 3.2.

21. The optical coating composition of claim 12, wherein a curing of said composition occurs at 50° C.

22. The optical coating composition of claim 12, wherein said acid having trifunctional groups comprising said two carboxylic acids and said α,β-unsaturated double bond is itaconic acid.

23. The optical coating composition of claim 22, wherein a molar ratio of said itaconic acid to a total volume of said silane of formula (1) and said silane of formula (2) ranges approximately is 1:8.13.

24. A method of preparing an optical coating composition that imparts an easy-cleaning, an anti-fogging and an anti-reflecting properties on a surface of an article comprising:
a) forming a first mixture in a first step by combining:
i) at least one silane of a formula (1);
R¹Si(OR₂)₃(Original)(Original)(Original) (1)
wherein R¹ comprises a reactive organic epoxide group and R² is a methyl group, an ethyl group, a propyl group or an isopropyl group;
ii) an alcohol component,
iii) water, and
iv) an acid having trifunctional groups comprising two carboxylic acid groups and an α,β-unsaturated double bond;
b) stirring said first mixture in said first step to allow said mixture to cool down to room temperature;
c) adding a silane compound having a formula (2) in said first step,
Si(OR²)₄(Original)(Original)(Original) (2)
wherein R² is a methyl group, an ethyl group, a propyl group or an isopropyl group;
d) forming a second mixture in a second step by diluting a portion of said first mixture and adding at least one additional alcohol component from said first mixture;
e) curing said second mixture formed at said second step at a range of temperatures and for a period of time.

25. The method of claim 24, wherein said curing of said second mixture formed at said second step occurs at 50° C. for 72 hours.

26. The method of claim 24, wherein forming said first mixture in said first step by combining said silane of formula (1) and said silane of formula (2) comprises a volumetric ratio between said silane of formula (1) and said silane of formula (2) in a range of approximately 0.2 to 2.0.

27. The method of claim 24, wherein forming said first mixture in said first step by combining said silane of formula (1) and said silane of formula (2) with said acid having said two carboxylic acid groups and said α,β-unsaturated double bond comprises a molar ratio between said acid and a total volume of said silane of formula (1) and said silane of formula (2) in a range of approximately 1:8.13.

28. The method of claim 24, wherein a pH of said second mixture by diluting said portion of said first mixture and adding said at least one additional alcohol component from said first mixture remains at 3.2.
